(19) United States
(12) Patent Application Publication
(10) Pub. No.: US 2020/0116228 A1
(43) Pub. Date: Apr. 16, 2020

(54) Dispenser for Wheel-Balancing Weights

(71) Applicant: WEGMANN automotive GmbH, Veitshöchheim (DE)

(72) Inventor: Mirko Pröstler, Himmelstadt (DE)

(21) Appl. No.: 16/710,610

(22) Filed: Dec. 11, 2019

Related U.S. Application Data
(63) Continuation of application No. PCT/EP2018/065259, filed on Jun. 11, 2018.

(30) Foreign Application Priority Data
Jun. 14, 2017 (EP) 17176055.6

(51) Int. Cl. F16F 15/32; G01M 1/32

(52) U.S. Cl. CPC F16F 15/328; G01M 1/326

(57) ABSTRACT

A balancing weight for vehicle wheels includes a plurality of balancing weight segments held by an adhesive tape. The balancing weight has a center mark formed by a partial cut between adjacent balancing weight segments at a position closest to the center of the balancing weight.

### CROSS-REFERENCE TO RELATED APPLICATIONS

This application is a continuation of pending International Application No. PCT/EP2018/065259 filed on 11 Jun. 2018, which designates the United States and claims priority from European Application No. 17176055.6 filed on 14 Jun. 2017. The disclosure of each of the above-identified applications is incorporated by reference herein.

### RELATED ART

### 1. Field of the Invention

The invention relates to an automatic dispenser for balancing weights, which may be self-adhesive balancing weights. Such balancing weights may be used for balancing wheels of vehicles.

### 2. Description of Relevant Art

For balancing vehicle wheels, balancing weights are used. Self-adhesive balancing weights include segments of a mass material that may be a metal (such as zinc or steel, for example) having a self-adhesive tape at one side, by which the mass material may be held to a rim of a wheel. Multiple pieces or segments of such a mass material are held together by a strip of adhesive tape, forming a chain or a belt of balancing weights. The self-adhesive tape is protected by a liner, also referred to as backing, at the side opposite to the balancing weight segments. Before applying a balancing weight to a rim, the liner is removed.

U.S. Pat. No. 3,960,409 shows such a belt of balancing weights, which may have a significant length and which may be wound up to a coil to simplify storage.

EP 1 128 176 A2 discloses a balancing weight having a plurality of weight elements being fully enclosed by a strip-like surface layer. The surface layer has partial cuts between adjacent weight elements, which extend from opposite lateral edges thereof in order to ease separation of a weight segment that includes one or more weight elements.

EP 3 040 578 A1 discloses a dispenser for balancing weights with a transport section configured to transport a belt of balancing weights segments and a cutting section configured to separate the belt of balancing weight segments into individual balancing weights.

EP 1 253 414 A2 discloses a complex dispensing device for balancing weights. Here, the liner is removed from the self-adhesive tape, then sections of balancing weight are cut from the tape and directly fed to an applicator. This device is intended for automatic tire balancing systems.

In tire workshops, the mass required for balancing a wheel is determined by a balancing machine, and a corresponding number of balancing weight segments is manually cut off from a belt of balancing weights. Then the liner is removed and the balancing weight is applied to a rim. Manually counting the number of required balancing weight segments and cutting them off is timeconsuming and prone to errors. To allow for manual handling, the balancing weight segments must have a minimum size which may be 10 or 5 grams. Lower masses would be difficult to handle, due to small size of the weight segments. This leads to a limited weight resolution and therefore to a limited balancing precision.

In automated systems a robot places the balancing weights to the rim. This robot can precisely determine the position of the balancing weights at the rim. When balancing weights are applied manually, the person applying the balancing weight must estimate the correct position of the balancing weight, as the balancing machine normally only indicates where to position the center of the balancing weight. If the center of the balancing weight does not fit to the indicated center position, there is a misbalancing of the wheel.

### SUMMARY OF THE INVENTION

The problem to be solved is to provide a balancing weight, a dispenser for balancing weights, and a method for marking balancing weights that allow precise positioning of a self-adhesive balancing weight at a wheel.

In an embodiment, a dispenser for balancing weights includes a transport section and a cutting section. The dispenser uses a belt of balancing weights including a plurality of three or more balancing weight segments that are held together by a self-adhesive tape, which may further be backed by a liner.

The transport section is configured to transport the belt of balancing weights to provide a desired amount or number of balancing weight segments, which are cut off from the belt by the cutting section. The cutting section includes at least one knife or cutter, which in operation is moved in a direction at right angle to the length (longitudinal extent) of the belt of balancing weights. The knife is moved between adjacent balancing weight segments to cut the self-adhesive tape for separating the balancing weight segments. Further tape layers, such as the liner, may be cut at the same time.

The dispenser provides a center mark at the balancing weight sections by making a partial cut in the self-adhesive tape and/or liner at the center or close to the center of the balancing weight section. The position of the partial cut is defined by the gap between adjacent balancing weights closest to the center of the balancing weight section. The center of such a section is between adjacent weight segments, if there is an even number of weight segments. In the case of an odd number of the weight segments, the position closest to the center between the two adjacent weight segments is selected. Alternatively, two partial cuts may be arranged at both sides of the center segment. In general, there may be 2 or more partial cuts that are places to indicate a center or a positioning range. The depth of the partial cut is selected such that the cut is clearly visible, but, at the same time, the segments are prevented from being separated from each other. The depth of the partial cut may be between 10% and 80% of the width of the self-adhesive tape, and preferably between 20% and 50% of the width of the self-adhesive tape. The section may be bent to better identify the partial cut.

The circumstances may exist, in which there are made multiple cuts in the self-adhesive tape, for example to simplify bending. In such cases, the partial cut may be shaped differently from the multiple cuts for the sake of identification. For instance, the partial cut may then have a larger depth and/or a larger width than the multiple cuts. In a related embodiment, the self-adhesive tape may be devoid of (does not contain, excludes) multiple cuts but only includes a partial cut.

It should be understood that very short balancing weights (formed by a combination of up to three balancing weight segments and, consequently, up to two gaps between adjacent balancing weight segments) may not at all have cuts with different shapes: different cuts may be at least partially identical to one another. However, with such very short balancing wheels, on the one hand, a center mark may not be really required for positioning, and, on the other hand, a robot or an experienced person may recognize the partial cut as being different from the multiple cuts.

Alternatively or additionally, the partial cut may be positioned or placed next to the multiple cuts with respect to a longitudinal direction of the belt of balancing weights, in which case the partial cut does not coincide longitudinally with the multiple cuts. Such a non-coincidingly placed partial cut may be narrower than the multiple cuts.

A related embodiment relates to a method of dispensing balancing weights by cutting balancing weight sections from a belt of balancing weights and providing a center mark formed by a partial cut, as described above.

A further embodiment relates to a balancing weight or balancing weight section having a partial cut as described above.

The transport section may include at least one transport roller or belt configure to move the belt of balancing weight by friction. To increase friction, there may be a counter roller or a counter belt for pressing the belt of balancing weights against the transport roller (or against the counter belt). A counter belt may be held and/or driven by a first pulley and a second pulley.

To further increase friction between the transport roller and the belt of balancing weights, the transport roller is equipped with a plurality of teeth that may be disposed at the outer circumferential surface of the transport roller.

These teeth may have a diameter and a length dimensioned such that the teeth intrude through the liner into the adhesive tape when the transport roller comes into contact with the belt of balancing weights. In an embodiment, the belt of balancing weights and transport roller are cooperated such that the teeth do not touch and/or damage the balancing weight segments. Experiments have shown, that such cooperation generates enough (that is, sufficiently high) friction to precisely pull upwards a long belt from a stock located at a significantly lower level than the drive section. The mass of balancing weights, which have to be lifted from the stock, may be of several kilograms. The teeth always allow a precise transport even with minimal slipping back of the belt of balancing weights. A precise transport is essential for quick and precise cutting at the cutting section as the cutting knife has to precisely fit into the gap between neighboring weight segments. The embodiment of the cutting section disclosed herein is more sensitive to position inaccuracies of the belt of balancing weights as the bending angle of the belt balancing weights is smaller than the 90′ angle known from related art, and therefore the gap between neighboring balancing weights is smaller than that addressed in the related art. Another advantage of the employment of the teeth at the transport roller is the perforation of the liner (caused by the teeth) with formation of small holes that reduces adhesion of the liner. This, in turn, significantly simplifies removal of the liner before applying the balancing weight to a rim of the wheel.

To improve the contact of the belt of balancing weights with the transport roller, and therefore to provide an operationally good/desired friction for transporting the belt of balancing weights, the counter belt and/or the counter roller may be additionally pressed against the transport roller. This can be accomplished by a tensioner at the belt of balancing weights or at one or both of the pulleys.

In an embodiment in which a second transport roller is present, the belt of balancing weights may be pressed against the second transport roller by at least a second counter roller, which may be spring-loaded.

The transport roller may be driven by a motor, or by a stepper motor. There may be present a gear between the motor and the transport roller. For example, a worm gear may be provided, as this configuration may block or prevent the belt from moving backwards (due to the weight of the balancing weights between the stock and the drive section) when there the power to the motor is cut off.

In one embodiment, the belt of balancing weight segments includes a plurality of balancing weight segments that are held together by an adhesive tape for attaching the balancing weight segments to a rim of a wheel. A plurality of balancing weight segments may also be held together by an additional carrier such as a plastic or metal tape or rod. The weight segments may include a mass material which may be a metal such as zinc, lead, steel, tungsten, aluminum, tin or any other suitable material which may be a plastic material or any combination thereof.

In a related embodiment, there may be present a backing or liner to protect the adhesive surface of the adhesive tape opposing to the balancing weights.

The adhesive tape may have at least one strengthening layer to increase the shear strength of the belt to simplify transport of the belt by the transport section.

The belt of balancing weights may be wound to a coil which supplies the transport section.

In an embodiment, the transport section may be configured to pull the balancing weights at the belt of balancing weights from a stock (which may represent a coil of balancing weights) and/or push the balancing weights into the cutting section. There may be present a slideway, configured as part of the cutting section, on which the balancing weights may slide horizontally.

In one implementation, the transport section may be dimensioned to form or defined an angle (which may be in the range between 70 and 110 degrees). In a specific case, such is 90 degrees. In operation of this specific embodiment, he transport section is disposed to receive the belt of balancing weights in a vertical direction (along a vertical axis), further redirecting the balancing weights along an axis in a horizontal direction. This may be done by curving or directing the belt of balancing weights at least partially around a transport roller. Generally, however, the components may be arranged in any other mutual orientation and not necessarily in horizontal and/or vertical directions.

As a person of skill will readily appreciate, for transporting a desired number of balancing weight segments, either the length of the transported belt may be measured, or the number of balancing weight segments in the belt may be counted. Alternatively, both methods may be used together to gain an additional reference and to increase the reliability of the process. For determining the length of the transported balancing weight belt, a slot wheel may be employed that has a plurality of slots, which slots may be detected and/or counted by means of a photo sensor (for example, as a result of analyzing an output signal from the photosensor with a programmable processor). In one case, such slot wheel is connected to the transport roller, but it may also be connected to any other roller or the belt. IN a related implementation, instead of a slot wheel, there may be used any other means for detecting the rotation motion, such as a resolver or an angle encoder, for example. There may also be used a drive motor configured to drive at least one of the wheels (for example, to drive the second transport roller), which in turn may have an angle encoder or which may be configured as a stepper motor. In the case of using a stepper motor, the number of steps provides a measure of the transported length of balancing weights.

Alternatively or additionally, there may be used at least one means configured to count the number of balancing weight segments. Such counting may be effectuated by detecting the gaps between the balancing weight segments, for example by means of a photo sensor or any optical sensor (based on the output signal generated by such sensor). To increase the width or the size of the gap between the neighboring weight elements or segments, the belt of balancing weights may be bent. In one embodiment, the belt of balancing weights is bent or curved as a result of passing the belt at least partially around the transport roller while counting the balancing weights passing by the first counter roller.

In one embodiment, the cutting section includes a belt guide, against which the belt of balancing weights is pushed by the transport section. The belt guide may be arc shaped and may form or define a curve (curved surface, for example) to bend or shape the belt of balancing weights into a curved form or to confirm the belt to the curve by redirecting the belt in a different direction, such that the gap between neighboring balancing weight segments increases or widens and a cutter (the belt-cutting component of the system) can pass through the gap between the neighboring segments to cut the belt into sections. The cutting of the belt may result in cutting the adhesive tape and/or the liner. The belt guide, when used, continuously forms of the belt, which is much quicker and less time-consuming than moving a counter holder on the belt to form the belt. Due to the continuous movement of the belt at the belt guide and lack of any pressing force applied to the belt, the probability of damaging, for example, scratching the surface of balancing weight segments is much smaller than in the case of using the system of related art.

In an embodiment, the belt guide is arc shaped. It may have an inner contour of an arc segment, dimensioned to guide the balancing weight segments along such contour. The radius of the arc segment may be in a range between 2 times and 20 times, or alternatively between 5 and 10 times the thickness and/or length of a balancing weight segment. The angle of the arc segment may be in a range between 30° and 150°, or it may be 90°. The arc may be shaped and disposed within the dispenser in such a fashion that the belt, transported along the belt guide in a horizontal plane, is deflected or redirected downwards. Here, the process of bending or spatially curving of the belt is supported by gravity.

In one embodiment, the components of the dispenser are appropriately dimensioned to ensure that the cutter easily passes between neighboring balancing weights that are to be separated. Such dimensioning of the system allows to use less cutting force and to avoid damage to the surface of the balancing weight segments. (The sides of the balancing weight segments along which the cutting occurs are the outer sides of the weights, which later become visible when the weights are applied to a wheel. For that reason, there should not be any scratches or other markings caused at such outer sides of the weights.)

In an embodiment, the cutter has a knife guide holding a knife; the cutter may be configured to move from one side of the belt of balancing weights to the other side. During such movement, the knife may be guided between two balancing weight sections. The knife may only be able to cut the adhesive tape (including backing or liner) connecting the balancing weight sections. The knife may not be configured to cut the material of balancing weight sections themselves (which may be made of steel or aluminum, or any other metal).

To avoid a blockage of the dispenser and/or damaging of the knife, a position sensor configured to detect gaps between neighbor balancing weights. The position sensor may be disposed over or near the position of the knife and/or the cutting path of the knife, to enable the sensor to detect a particular gap that is used by the knife for cutting. The position sensor may also be located at a separation distance, which equal to at least one balancing weight width, from the position of the knife. If the separating distance is too large, there may be changing distances between the detected position and an open gap due to mechanical tolerances and or stretching of the belt. The position sensor may be an optical sensor, but in a related embodiment it may be a magnetic sensor, an inductive sensor, or any other appropriate sensor configured to detect a balancing weight segment and/or a gap between balancing weights and/or weight segments.

For dispensing certain mass of balancing weights, first the required number of balancing weight segments may be calculated (for example, using an output signal of the appropriate sensor operably cooperated with the belt of balancing weights), unless this number is already known. Further, the motor may be operated for a certain time, or for a certain number of steps in the case of a stepper motor to push the required number of balancing weight segments towards the belt guide. The motion of the motor may be stopped, if and when, after the required number of balancing weight segments have passed the sensor, the position sensor has detected a gap.

Then the knife is caused to move through the detected gap and to separate, cut off the required number of balancing weight segments from the belt.

Bending the belt with the use of the belt guide further reduces mechanical stress to the adhesive tape. Indeed, if instead of bending the belt, the balancing weight segments were simply pushed apart to produce a gap between two balancing weight segments, the comparatively flexible self-adhesive tape or foam would expand or lengthen, while the less flexible backing or liner would tear or at least separate from the tape. Such consequences are prevented by the belt-bending procedure as disclosed above. For manually handling the process of cutting the balancing weight segments it is essential that the liner remains in place. Otherwise, the cut segments would immediately stick to a tray into which the dispenser delivers the cut segments.

After a certain number of balancing weight segments have been cut by the cutter, they may slide and/or fall, driven by gravity, along the vertical side of the cutter base and into a tray, from which they are further disbursed or taken out and attached to a rim of a wheel.

The cutting section and the transport section of an embodiment may be used together, in the same process, as described herein. Alternatively, the cutting section may be used without a transport section, or with a different transport section. For example, the transport section may be simplified and use only a first transport roller and a first counter roller to generate the required friction to the belt of balancing weights.

The embodiments described herein allow for and facilitate automatic cutting of required mass sections form a belt of balancing weights. Due to the automatic transport and cutting, a high speed can be achieved and a large number of balancing weight can be processed in a short time interval. Furthermore standard size segments of balancing weights as well as smaller and even significantly smaller segments can be processed. This may result in a much better balancing mass resolution as compared to manual processing. Conventional balancing weight segments often are designed to have a size that can easily be handled. Therefore, lightweight segments may be comparatively thin, resulting in a larger surface, which can better be gripped or utilized, or the segments may be made of a low density material resulting in a larger size of a given segment. When an embodiment of the invention is employed, one can afford to have the balancing weight segments of very small sizes as there is no need to increase the segment size for manual handling of every segment.

Due to the automated cutting, a more mechanically stable and robust adhesive tape may be used. It may even have a robust support layer included. While it may be impossible to manually produce a clean cut for separating weight segments, the automated cutting with a guided knife and the balancing weights held in a predetermined position at the cutter edge will produce and result in a precise cut. Furthermore, the size of the balancing weight segments may be reduced to smaller sizes (such as 5g, 2g, 1g or less). This increases resolution and therefore balancing precision. It is appreciated that today such small balancing weights can only be handled by an automated dispenser as they are too small for manual handling.

A further embodiment relates to a method for delivery of cut sections of balancing weights. The method includes the steps of transporting a certain number of balancing weight segments being part of a belt of balancing weights to a belt guide, bending the balancing weights extending such that a gap opens between two adjacent balancing weight segments and moving a knife from one side of the belt of balancing weights to the other side of the belt of balancing weights, and therefore cutting a balancing weight from the belt of balancing weights.

### BRIEF DESCRIPTION OF THE DRAWINGS

In the following, the invention will be described by way of examples and without limitation of the general inventive concept, with reference to the drawings, of which:

FIG. 1 shows an embodiment of a balancing weight;

FIG. 2 shows another embodiment of a balancing weight;

FIG. 3 illustrates an embodiment of a dispenser;

FIG. 4 presents an alternative embodiment of a dispenser;

FIG. 5 shows a transport roller in detail;

FIG. 6 depicts a sectional view of the slideway;

FIG. 7 shows the cutter in an operational state; and

FIG. 8 shows the cutter in an idle state.

While the invention can be variously modified and assume alternative forms, specific embodiments of the invention are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

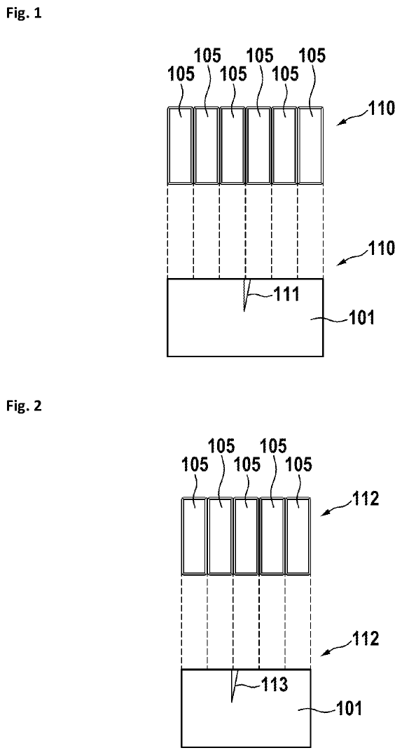

FIG. 1 illustrates a first embodiment of a balancing weight 110 that includes an even number of balancing weight segments 105. The upper portion of FIG. 1 shows the balancing weight 110 in a top view, while the lower portion shows the balancing weight 100 in a bottom view, such that the adhesive tape 101 can be seen. The dashed lines between the upper and lower portions indicate the positions of the balancing weight segments 105. A partial cut 111 is at the center of the balancing weight 110 between the adjacent balancing weight segments 105 closest to the center (the third weight segment as viewed from any side of FIG. 1). This partial cut 111 identifies the center of the balancing weight 110 and represents, therefore, a centering mark. Here, only a small-size balancing weight 110 is shown to demonstrate the basic concept. As a person of skill will readily appreciate, the center indicator (the centering mark that includes the partial cut 111) is more useful at larger (longer) balancing weights that include a larger number of weight segments.

FIG. 2 shows another embodiment with a balancing weight 112 having an odd number of weight segments 105. A partial cut 113 is placed at a position close to the center of the balancing weight 112 between the adjacent balancing weight segments 105 closest to the center of the balancing weight 112. In this embodiment, the partial cut 113 is between the second and the third balancing weight segment 105, as seen from the left.

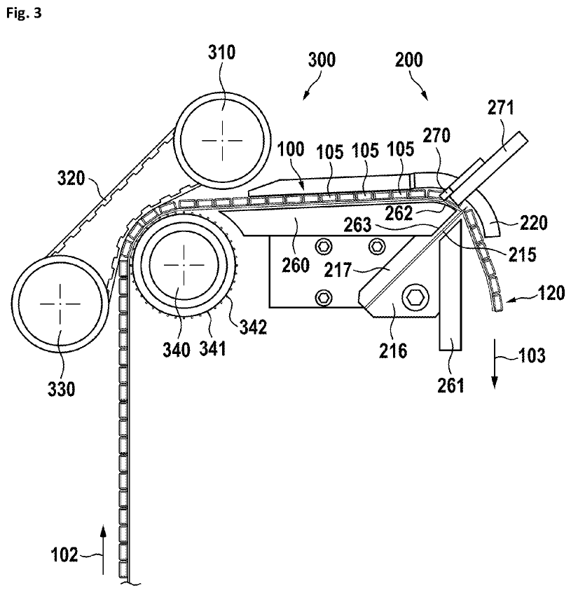

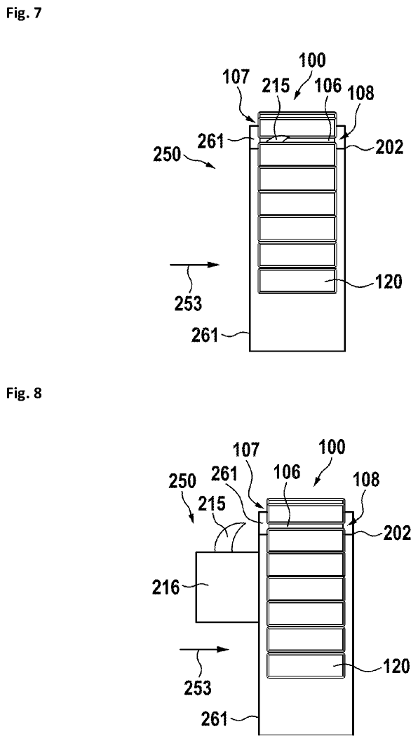

In FIG. 3, an embodiment of a dispenser is shown in a side view. The dispenser includes a transport section 300 and a cutting section 200. A belt of balancing weights 100 is fed (delivered) by a drive mechanism to the cutting section 200 (which includes a cutter 250, shown in FIGS. 7, 8), where desired portions of mass material are cut from the belt of balancing weights 100. In this embodiment, a belt of balancing weights 100 including of a plurality of individual balancing weight segments 105, is fed/delivered from the left side of the dispenser in a feeding direction 102 into the transport section 300 of the dispenser. In a related case, there may be a coil (not shown) configured to supply the balancing weights 110, 112. In one embodiment, a transport roller 340 is configured to transport the belt of balancing weights 100 (that has balancing weight segments 105), which may be delivered coming from an approximately vertical first, initial direction (a portion of the belt of the balancing weights is shown stretched along the direction of gravity, in the left-hand side of FIG. 3) into an approximately horizontal, second direction (as indicated by the portion of the belt 100 between the transport roller 340 and the cutting section 200), for the ease of cutting the belt 100. A counter belt 320, which may be suspended between a first pulley 310 and a second pulley 330, and which is shown to be configured to press the belt of balancing weights 100 against the transport roller 340, in operation provides for and generates friction to and with the belt of balancing weights 100. The degree of friction may further be increased by utilizing teeth 341, 342 at the transport roller 340. In an embodiment, at least the transport roller 340 is driven by a motor (not shown). To determine the precise amount of balancing weight mass material, which has been transported, an angle encoder or counter may be provided.

After passing the transport roller 340, the balancing weights 110, 112, 120 are pushed in an approximately horizontal direction (a second direction that is transverse to the initial, first direction of propagation of the belt of balancing weights 100 prior to interaction between the belt of balancing weights 100 and the transport roller 340), and are guided by a slideway 260 towards the cutting section 200. The slideway 260 has an end section or portion 263, which may be a appropriately curved, 262, closely before and next to the output end of the end section 263. Cutting may be carried out by a knife 215, which is disposed to pass close to the end section 263 of the slideway 260. The knife, at least in one case, may be held by a knife holder 216 and may be locked/affixed to the knife holder by a counter holder 217.

Before the instance of cutting off a particular section 120 of the belt of balancing weights 100, the belt of balancing weights 100 is bent or redirected to an angle of 90° or smaller, from the second direction, by pushing the belt of balancing wheels 100 against a curved belt guide 220. Bending of the belt 100 may further be supported and/or enhanced by the presence of the curved section 262 of the slideway 260 on the opposite side of the belt 100 from the curved belt guide 220.

The balancing weights 110, 112 of the section 120 of the now-curved belt of balancing weights 100 form a gap 106 (shown in FIG. 7, for example) between the adjacent balancing weight segments of the section 120 and the section of the belt supported by the curved section o263 of the slideway 260, which allows the knife 215 to slide or pass between these two adjacent balancing weights. After the belt 100 was re-shaped/bent to form the angle as discussed above, the cutter 250 portion of the cutting section 200 including a knife 215 is moved from one side 107 to the other side 108 through the belt of balancing weights 100, cutting the adhesive tape 101 between two balancing weight segments 105, without cutting the balancing weight segments 105 themselves, and therefore separating a balancing weight 120 from the belt of balancing weights 100.

To transport and/or position the belt of balancing wheels 100 to ensure that the knife 215 exactly passes through a gap 106 between adjacent balancing weights 110, 112, 120, a position sensor 270 may be utilized, which may be held by a sensor holder 271. The position sensor 270 may be arranged such that it detects the specific gap 106 through which the knife 215 passes or an adjacent gap 106 (that is, a gap that neighbors the gap 106 through which the knife 215 passes). The position sensor 270 may be structured as an optical sensor or as a magnetic sensor.

After the belt of balancing weight 100 has been cut—the cut-off section (the balancing weight) 120 slides or falls down along the sidewall 261 towards and in a delivery direction as indicated by an arrow 103, and may be further delivered to a tray from which it can be further removed by either a robot or a person to be applied to a wheel.

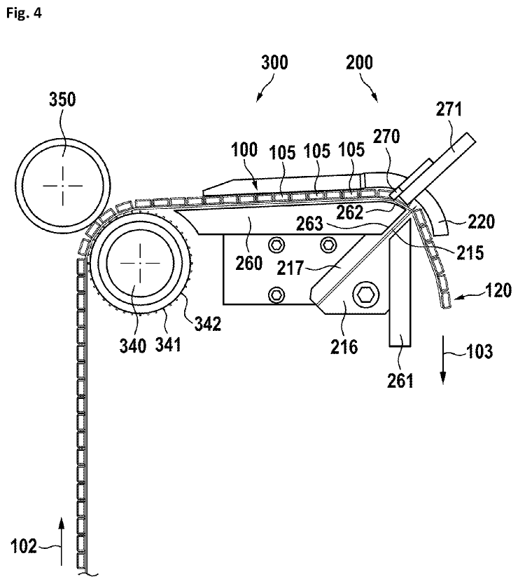

FIG. 4 shows an alternative embodiment, similar to the embodiment above. Here, however, instead of the counter belt 320 a counter roller 350 is provided to establish friction with the belt of balancing weights 100.

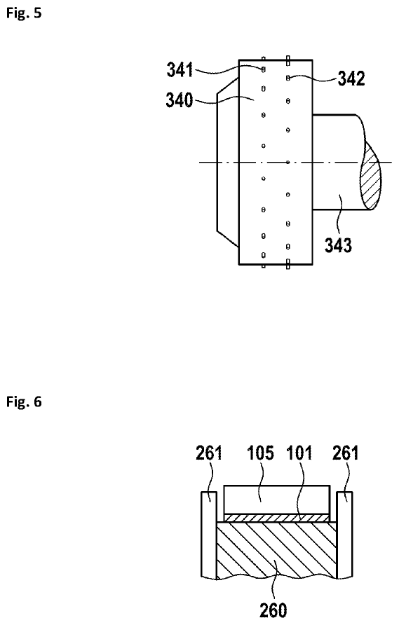

FIG. 5 illustrates a transport roller 340 in detail. The transport roller 340 may be driven by a driveshaft 343 and via an optional gearbox (not shown) by a motor (not shown). The transport roller 340 may have a cylindrical shape. It may be structured to have a plurality of teeth 341, 342 or spikes at its outer circumference. In operation, these teeth 341, 342 penetrate into the adhesive tape 101 of the belt of balancing weights 100 and improve/increase friction for precise transport of the belt of balancing weights 100. In one embodiment, multiple rows of teeth 341, 342 are present that may be displaced against (with respect to) each other.

FIG. 6 shows a sectional view of the slideway 260. The slideway 260 may have at least one sidewall 261 to prevent the belt of balancing weights 100 from sliding off the slideway 260. At the top of the slideway 260, a belt of balancing weights 100 that includes multiple balancing weight segments 105 on an adhesive tape 101, may be pushed forward by the transport roller 340.

In FIG. 7, the operational state of the cutter 250 including a knife holder 216 with an attached knife 215 is shown. This image is a sectional view from right side of FIG. 1 to the cutter 250. Due to the bending the belt of balancing weights 100 at and along the curved belt guide 220, a gap 106 is formed at the cutting edge 202, at which the knife 215, attached to a knife holder 216, is moved in a cutting direction 253 (across the belt 100) from a first side 107 of the belt of balancing weights 100 to the second side 108 of the belt 100 to separate the balancing weight (section) 120 from the belt of balancing weights 100.

In FIG. 8, the cutter 250 is shown in an idle state, where the knife 215 is located next to the belt of balancing weights 100.

It will be appreciated to those skilled in the art having the benefit of this disclosure that this invention is believed to provide balancing weights and dispensers for balancing weights. Further modifications and alternative embodiments of various aspects of the invention will be apparent to those skilled in the art in view of this description. Accordingly, this description is to be construed as illustrative only and is provided for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

100 belt of balancing weights
101 adhesive tape
102 feeding direction
103 delivery direction
105 balancing weight segment
106 gap between balancing weight segments
107 first side
108 second side
110 balancing weight with even number of segments
111 partial cut
112 balancing weight with odd number of segments
113 partial cut
120 cut balancing weight
200 cutting section
202 cutting edge
215 knife
216 knife holder
217 counter holder
220 belt guide
250 cutter
253 cutting direction
260 slideway
261 sidewall
262 curved section
263 end section
270 position sensor
271 sensor holder
300 transport section
310 first pulley
320 counter belt
330 second pulley
340 transport roller
341 tooth
342 tooth
350 counter roller

1. A dispenser of balancing weights for vehicle wheels, wherein a balancing weight comprises a plurality of balancing weight segments held by an adhesive tape that has a partial cut between adjacent balancing weight segments at a position closest to a center of the balancing weight,
said dispenser comprising:
a transport section, and
a cutting section,
wherein the transport section comprises a transport roller that is configured to transport a belt of balancing weights, including a plurality of said individual balancing weight segments, to the cutting section, and that has a plurality of teeth at a circumferential outer surface thereof, the plurality of teeth configured to generate friction to the belt of balancing weights, and
wherein the cutting section having a knife configured to be moved from a first side of the belt of balancing weights to a second side of the belt of balancing weights to separate balancing weights from said belt and to form said partial cut at a gap between said adjacent balancing weight segments.

2. The dispenser according to claim 1, wherein the cutting section (200) has an arc shaped belt guide configured to conform the belt of balancing weights to a curve to widen said gap.

3. The dispenser according to claim 1, comprising at least one of a counter roller and a counter belt, wherein said at least one of the counter roller and the counter belt is configured to press the belt of balancing weights against the transport roller to increase friction therebetween.

4. The dispenser according to claim 1, comprising a sensor configured to detect gaps between individual balancing weights.

5. The dispenser according to claim 4, wherein the sensor is mounted at a location at the cutting path of the knife.

6. The dispenser according to claim 4, configured to use a signal from the sensor to determine a number of balancing weight segments.

7. A method for delivering balancing weights according to claim 1, the method comprising:
transporting a desired number of balancing weight segments that are part of a belt of balancing weights to a belt guide,
moving a knife between adjacent balancing weight segments from one side of the belt of balancing weights towards another side of the belt of balancing weights, to form said partial cut at the position closest to the center of the balancing weight, and
moving the knife between adjacent balancing weight segments from one side of the belt of balancing weights to the other side of the belt of balancing weights, to cut off a chose balancing weight from the belt of balancing weights.

8. The method according to claim 7, wherein said transporting includes transporting the desired number of balancing weight segments to the belt guide that is arc shaped to conform the belt of balancing weights to a curved surface of the [symbol]
